(19) United States
(12) Patent Application Publication
(10) Pub. No.: US 2026/0274186 A1
(43) Pub. Date: Sep. 17, 2026

(54) FOAM BODY FOR SENSORS USED WITH PEDESTRIAN SAFETY

(71) Applicant: Rivian IP Holdings, LLC, Irvine, CA (US)

(72) Inventors: Baha Jehad Husni EL FAR, Irvine, CA (US); Daniel CALDER, Rancho Mission Viejo, CA (US); Bernardo Barajas ARIAS, Irvine, CA (US)

(21) Appl. No.: 19/078,123

(22) Filed: Mar. 12, 2025

(51) Int. Cl. B60R 19/02; B60R 19/18; B60R 19/48

(52) U.S. Cl. CPC B60R 19/023; B60R 19/48; B60R 2019/1806; B60R 2019/1873

(57) ABSTRACT

A vehicle includes a body (e.g., foam body) designed to compress in response to an applied force. The body includes cut out portions to reduce the amount of applied force required to compress the body in order for the body to compress and become detectable by a sensor. The body may be attached to a bracket and a lamp carrier, with the bracket providing stiffness and facilitation of the compression of the body.

### INTRODUCTION

This application is directed to vehicles, and more particularly, to foam bodies for pedestrian safety applications in vehicles.

### SUMMARY

The subject technology is directed to packaging a body (e.g., foam body) and a sensor assembly (e.g., pressure tube sensor) in a front end of a vehicle. Using a bracket, the body and sensor assembly may be coupled with a carrier for lamps of the vehicle in the front end of the vehicle, with the bracket being relatively less stiff than a bumper beam assembly of the vehicle.

In one or more aspects of the present disclosure, an apparatus is described. The apparatus may include a body configured to couple with a lamp carrier of a vehicle. The body may include a first surface. The body may further include a second surface opposite the first surface. The body may further include a first cut out portion formed into the second surface. The body may further include a second cut out portion formed into the second surface. In response to the body at the first surface, the body may be configured to compress, based on the first cut out portion and the second cut out portion, and trigger one or more sensing devices of a sensor assembly.

The apparatus may further include a third cut out portion formed into the second surface and positioned between the first cut out portion and the second cut out portion. The third cut out portion may be configured to receive the sensor assembly.

The apparatus may further include a bracket configured to cover the second surface and secure with the lamp carrier. The body may include a foam body.

The apparatus may further include one or more extensions that extend from the foam body. The one or more extensions may be configured to receive a fastener to couple the foam body with the lamp carrier. The first surface may define an indentation configured to conform to the vehicle.

The body may define a first end and a second end opposite the first end. The first cut out portion and the second cut out portion may extend from the first end to the second end.

In one or more aspects of the present disclosure, a subassembly is described. The subassembly may include a lamp carrier configured to carry a plurality of lamps for a vehicle. The subassembly may further include a bumper beam assembly including a bumper beam for the vehicle The subassembly may further include a body configured to couple with the lamp carrier. The body may include a first surface. The body may further include a second surface opposite the first surface. The body may further include a first cut out portion formed into the second surface. The body may further include a second cut out portion formed into the second surface. The body may further include a third cut out portion formed into the second surface and positioned between the first cut out portion and the second cut out portion. The subassembly may further include a sensor including one or more sensing devices positioned in the third cut out portion. In response to an applied force to the body at the first surface, the body may be configured to compress, based on the first cut out portion and the second cut out portion, and trigger the one or more sensing devices.

The subassembly may further include a bracket configured to cover the second surface and secure with the lamp carrier. The lamp carrier may be carried by the bumper beam assembly. The body may include a foam body.

The subassembly may further include one or more extensions that extend from the foam body. The one or more extensions may be configured to receive a fastener to couple the foam body with the lamp carrier. The body may be separated from the bumper beam by the bumper beam assembly. The first surface may define an indentation configured to conform to the vehicle. The body may define a first end and a second end opposite the first end, and the first cut out portion and the second cut out portion extend from the first end to the second end.

In one or more aspects of the present disclosure, a vehicle is described. The vehicle may include a bumper beam assembly including a bumper beam. The vehicle may further include a bumper that convers the bumper beam. The vehicle may further include a lamp carrier configured to carry a plurality of lamps. The lamp carrier may be carried by the bumper beam assembly. The vehicle may further include a body coupled with the lamp carrier of a vehicle. The body may include a first surface, a second surface opposite the first surface, a first cut out portion formed into the second surface, a second cut out portion formed into the second surface, a third cut out portion formed into the second surface and positioned between the first cut out portion and the second cut out portion. The vehicle may further include a sensor including one or more sensing devices positioned in the third cut out portion. In response to an applied force to the body at the first surface, the body may be configured to compress, based on the first cut out portion and the second cut out portion, and trigger the one or more sensing devices.

The vehicle may further include a bracket configured to cover the second surface and secure with the lamp carrier. The body may define a first surface and a second end opposite the first surface, and the first cut out portion and the second cut out portion extend from the first surface to the second surface. The body may be separated from the bumper beam by the bumper beam assembly.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with one or more aspects of the present disclosure.

FIG. 2 illustrates a side view of an alternate example of a vehicle, in accordance with one or more aspects of the present disclosure.

FIG. 3 illustrates a front view of a vehicle, in accordance with aspects of the present disclosure.

FIG. 4 illustrates an enlarged side view of a vehicle, showing a hood actuator located in the vehicle, in accordance with aspects of the present disclosure.

FIG. 5A illustrates a perspective view of a carrier and an assembly, in accordance with aspects of the present disclosure.

FIG. 5B illustrates a perspective view of the sensor assembly 534, in accordance with aspects of the present disclosure.

FIG. 6 illustrates a rear perspective view of a body, in accordance with aspects of the present disclosure.

FIG. 7 illustrates a rear perspective view of a body, further showing a bracket coupled with the body, in accordance with aspects of the present disclosure.

FIG. 8 illustrates a partial cross sectional view showing a body for a vehicle, in accordance with aspects of the present disclosure.

FIG. 9 illustrates a partial cross sectional view showing the body in FIG. 8 under compression, in accordance with aspects of the present disclosure.

FIG. 10 illustrates a partial cross sectional view showing a body integrated with a vehicle, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to locating, in a vehicle, a package that includes a body (e.g., foam body) and a sensor assembly. The body may include an opening (e.g., cut out region, canal), thereby allowing the sensor assembly to be positioned in the opening and between the body and another component (e.g., bracket). In one or more implementations, when the body is compressed, the sensor assembly detects a change of pressure (e.g., within a tube), which initiates a region (e.g., rear portion) of a vehicle's front hood to open, thereby providing enhanced safety to pedestrians that contact the vehicle by limiting the impact to the pedestrians. Traditionally, the package is coupled with a bumper beam assembly, including a steel plate used to carry a bumper of the vehicle. However, the steel plate may provide a relatively stiff structure that is not compatible or compliant with some industry standards for pedestrian safety. In this regard, a bracket is used to couple the package to carrier for the vehicle's lamps. The bracket may include a non-metal (e.g., polymer-based) support structure that couples to a back surface of the body, thereby providing a surface along which the body may compress. Further, the body may include one or more cutouts that enables compression of the body at lower forces and impact energies. By lowering the force required to compress the body and allow the sensor assembly to detect a pressure change, the sensor assembly may be responsive to lower-mass forces, such as due to pedestrian impact from smaller individuals (e.g., children).

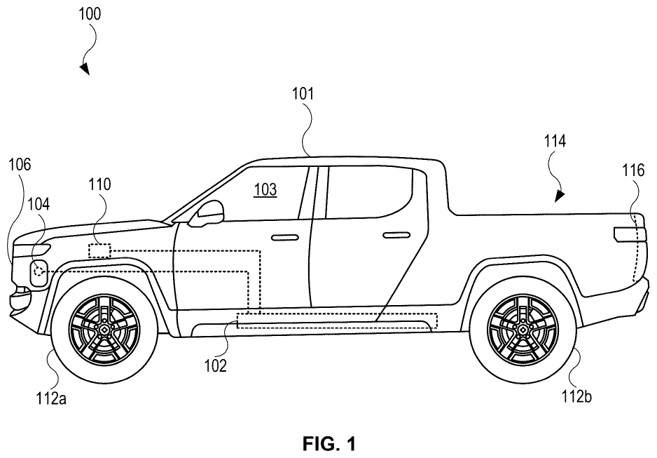

FIG. 1 illustrates a side view of an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. While the port is shown on the front driver's side of the vehicle 100, the port 104 may be located in other region such as a rear passenger side (not shown in FIG. 1) of the vehicle 100. The vehicle 100 may further include a front end 106 at which one or more lamps (shown below) are generally positioned.

As another exemplary electrical system, the vehicle 100 may include a drive unit 110, representative of one or more additional drive units of the vehicle 100. The battery pack 102 may couple to the drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

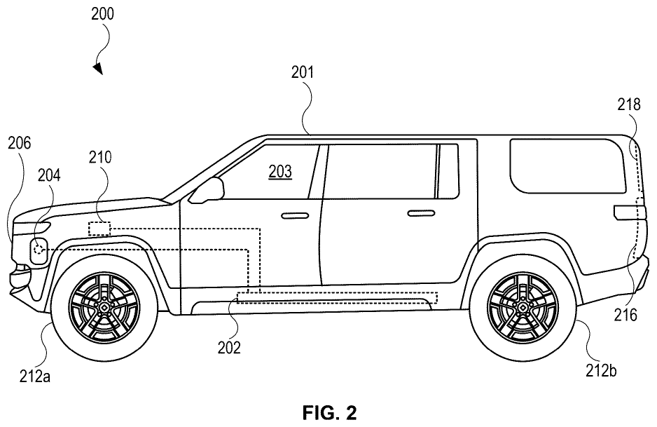

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a front end 206, a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

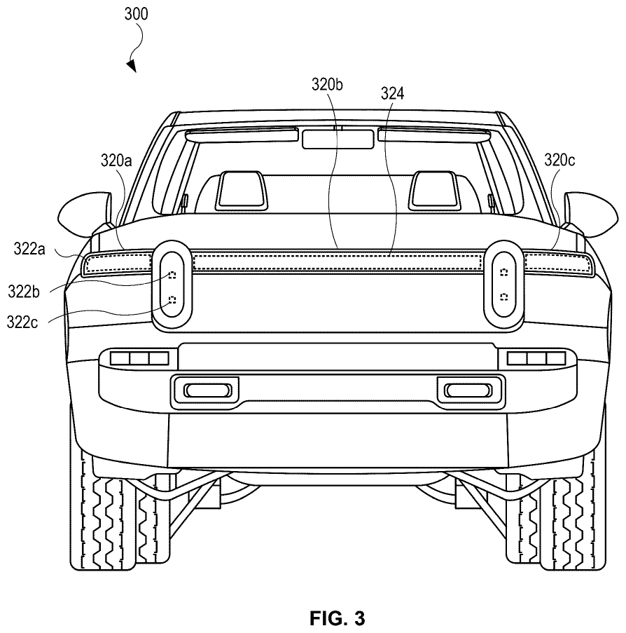

FIG. 3 illustrates a front view of a vehicle 300, in accordance with aspects of the present disclosure. Each of the vehicle 100 (shown in FIG. 1) and the vehicle 200 (shown in FIG. 2) may include any features shown and/or described herein for the vehicle 300. Further, the vehicle 300 may take the form of a truck (e.g., vehicle 100 shown in FIG. 1) or an SUV (e.g., vehicle 200 shown in FIG. 2).

The vehicle 300 may include several lamps. For example, in one or more implementations, the vehicle 300 includes a lamp 320a, a lamp 320b, and a lamp 320c. Each of the lamps 320a, 320b, and 320c may include one or more lights sources designed to illuminate and increase visibility for passengers of the vehicle 300. For example, the lamp 320a includes a light source 322a, a light source, 322b, and a light source 322c. The light sources 322a, 322b, and 322c may be representative of additional light sources for the lamp 320a as well as the lamp 320c. Also, the lamp 320b may include a light source 324 representative of one or more light sources. Each of the described light sources may take the form of an LED or an incandescent bulb, as non-limiting examples. The lamps 320a and 320c may each be referred to as a headlight or head lamp, and the lamp 320b may be referred to as a center lamp. The vehicle 300 may further include a power supply (not shown in FIG. 3), such as a battery pack (e.g., similar to the battery pack 102 shown in FIG. 1), that provides energy (e.g., electrical energy) that causes the light sources 322a, 322b, 322c, and 324 to illuminate.

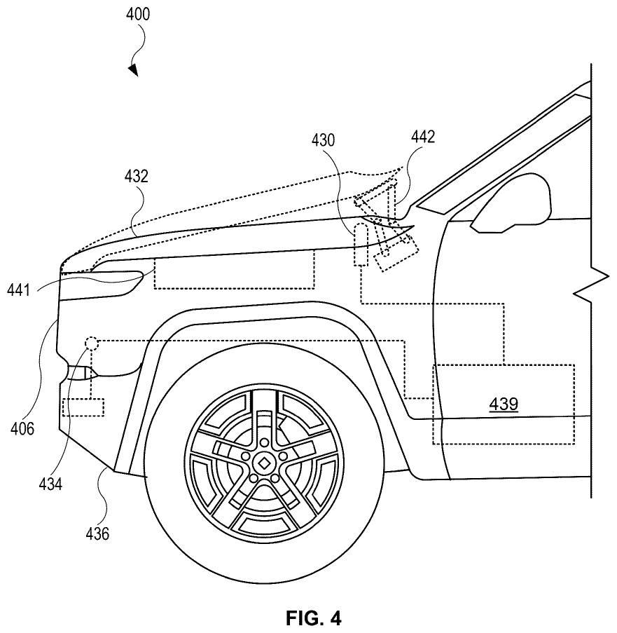

FIG. 4 illustrates an enlarged side view of the vehicle 400, showing the hood actuator 430 located in an alternate location of the vehicle 400, in accordance with aspects of the present disclosure. Similar to prior examples, the hood actuator 430 may be used to release the hood 432. However, as shown in FIG. 4, the hood actuator 430 is located at or near a rear portion of the hood 432. Based in part on the hinge 442, the hood 432 may transition from a closed position to an open position (shown a dotted lines).

As an exemplary application, when an object comes into contact with the bumper 436, the momentum of the object may cause the object to contact the hood 432. Moreover, in some instances, when the object is moving toward the vehicle 400, the additional momentum of the object may cause the object to contact the hood 432. However, based on the location of the hood actuator 430, when the sensor assembly 434 may detect the object based on a change in pressure (as an example) and transmit a signal to a controller 439. As non-limiting examples, the controller 439 may take the form restraints control module (RCM), also known as an airbag control unit (ACU). The controller 439 may provide a command to the hood actuator 430, which causes actuation of one or more components (not shown in FIG. 4) of the hood actuator 430 to open the hood 432. In particular, the hood actuator 430 may provide a force that causes the hinge 442 to open the hood 432. Similar to a prior example, the hood actuator 430 is designed to react to the signal from the controller 439 and actuate to cause the hood 432 to open prior to the object making contact with the hood 432. Beneficially, the impact to the object, such as a pedestrian, may be relatively limited based on the hood 32 opening. Accordingly, the deployment of the hood 432 may function as a safety measure to minimize injury to a pedestrian. It should be noted that the hood 432 may also be opened (e.g., by alternate means) to allow a user to further manually open the hood 432 and gain access to a space 441 (e.g., frunk) of the vehicle 100. Also, in one or more implementations, the vehicle 400 may include an airbag that deploys based on a command from the controller 439, which may occur due to the controller 439 receiving an input from the sensor assembly 434 (e.g., due to a detected pressure change from the sensor assembly 434). In this regard, the airbag may deploy at or near the same time as the hood 432 to cover, or at least partially cover, the hood 432. The airbag may be deployed by as a command from the controller 439 and when the sensor assembly 434 detects a pressure change.

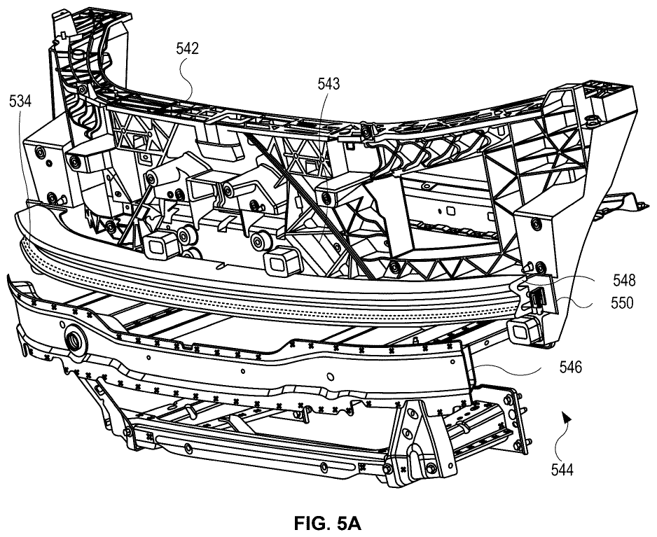

FIG. 5A illustrates a perspective view of a lamp carrier 542 and an assembly 544, in accordance with aspects of the present disclosure. The lamp carrier 542 is designed for use in a vehicle (e.g., vehicles 100, 200, 300, 400 shown in FIG. 1, FIG. 2, FIG. 3, and FIG. 4, respectively) to hold lamps (e.g., lamps 320a, 320b, and 320c shown in FIG. 3). The lamp carrier 542 may be designed (e.g., molded, stamped) to conform to a shape of a vehicle (e.g., front end 106 of the vehicle 100 shown in FIG. 1, front end 206 of the vehicle 200 shown in FIG. 2, front end 406 of the vehicle 400 shown in FIG. 4). Also, a bracket 543 may be integrated with the lamp carrier 542 in order to increase the stiffness of the lamp carrier 542.

The assembly 544 may take the form of a bumper beam assembly that holds a bumper (e.g., bumper 436 shown in FIG. 4). In this regard, the assembly 544 includes a plate 546 designed to carried the bumper. The plate 546 may include a metal plate that includes steel, as a non-limiting example. In one or more implementations, the lamp carrier 542 is coupled with (e.g., fastened to, adhered to, clipped to, etc.) the assembly 544.

Additionally, a body 548 may be coupled with the lamp carrier 542. In one or more implementations, the body 548 takes the form of a foam body. In this regard, the body 548 may compress or deform when an applied force is exerted on the body 548. The body 548 may subsequently return to its original, prior shape when the applied force (other than gravity) is removed. Alternatively, the body 548 may take the form one or more elastic materials that returns to its original, prior shape when the applied force is removed.

As shown, the body 548 may cover a sensor assembly 534 (shown as dotted lines) designed to monitor impact to a vehicle. The sensor assembly 534 may include any form of a sensor described for the sensor 434 (shown in FIG. 4). In one or more implementations, the sensor assembly 534 takes the form of a pressure sensor. The body 548 may be positioned in a vehicle to absorb energy from an object (e.g., a pedestrian), causing the body 548 to compress. In some examples, the body 548 may compress and contact/engage the sensor assembly 534, causing one or more components of the sensor assembly 534 to undergo a change in pressure. When the change in pressure of the component(s) of the sensor assembly 534 is at or above a threshold pressure, the sensor assembly 534 may initiate opening of a hood (e.g., hood 432 shown in FIG. 4).

The body 548 may couple with the lamp carrier 542 by a bracket 550. In one or more implementations, the bracket 550 takes the form of a non-metal (e.g., polymer-based or plastic) bracket. In this regard, the bracket 550 may be less stiff than the plate 546. The relatively low stiffness of the bracket 550 may allow a vehicle to be in compliance with industry standards for vehicle safety, whereas the plate 546 may provide a relatively higher stiffness that prevents compliance with the industry standard. Also, the bracket 550 may include one or more attachment points (not shown in FIG. 5) to couple or secure the bracket 550 with the lamp carrier 542.

FIG. 5B illustrates a perspective view of the sensor assembly 534, in accordance with aspects of the present disclosure. The sensor assembly 534 may include an assembly of components. For example, the sensor assembly 534 may include a tube 535, a sensing device 537a, and a sensing device 537b, with the sensing devices 537a and 537b connected on each side of the tube 535, blocking the full diameter of the tube 535. The sensing devices 537a and 537b may include a membrane (not shown in FIG. 5B) to create a relief in case a temperature changes causes a pressure change inside the tube 535, thus removing unwanted pressure change detection due to the increase in temperature or altitude. In one or more implementations, the sensor assembly 534 includes detection step, a discrimination step, and step. The detection may refer to a foam body (e.g., body 548 shown in FIG. 5A) compressing, causing compression of the tube 535 and generating air pressure in both ends of the tube 535 that leads to at least one of the sensing devices 537a and 537b sending a signal to a controller (e.g., controller 439 shown in FIG. 4). The controller may perform the discrimination step by comparing the signal based on the vehicle speed and the duration of the signal to specific thresholds. When the signal is deemed as (e.g., corresponds to) a pedestrian, the controller may trigger the signal for deployment, i.e., the action step. The controller may trigger hinges (e.g., hinge 442 shown in FIG. 4, representing one or more hinges) in the hood (e.g., hood 432 shown in FIG. 4), thereby creating a space between the hood and the internals of the vehicle.

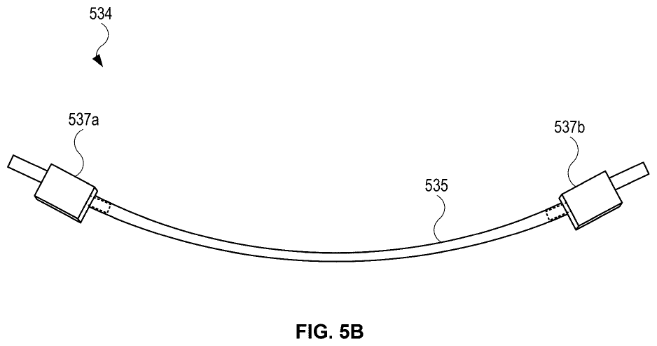

FIG. 6 illustrates a rear perspective view of the body 548, in accordance with aspects of the present disclosure. The body 548 may take the form of an apparatus. The body 548 may include several extensions, or attachments, utilized to couple the body 548 with a lamp carrier (e.g., lamp carrier 542 shown in FIG. 5). For example, the body may include an extension 556a, an extension 556b, an extension 556c, an extension 556d, an extension 556e, and an extension 556f. Each of the extensions 556a, 556b, 556c, 556d, 556e, and 556f may include an opening to receive a fastener or a clip (not shown in FIG. 6) to couple the body 548 with a lamp carrier. Also, the extensions may be located on different surfaces. For example, the extensions 556a, 556b, 556c, and 556d are located on a surface 558a of the body 548, while the extensions 556e and 556f are located on a surface 558b of the body 548, with the surfaces 558a and 558b representing opposing surfaces.

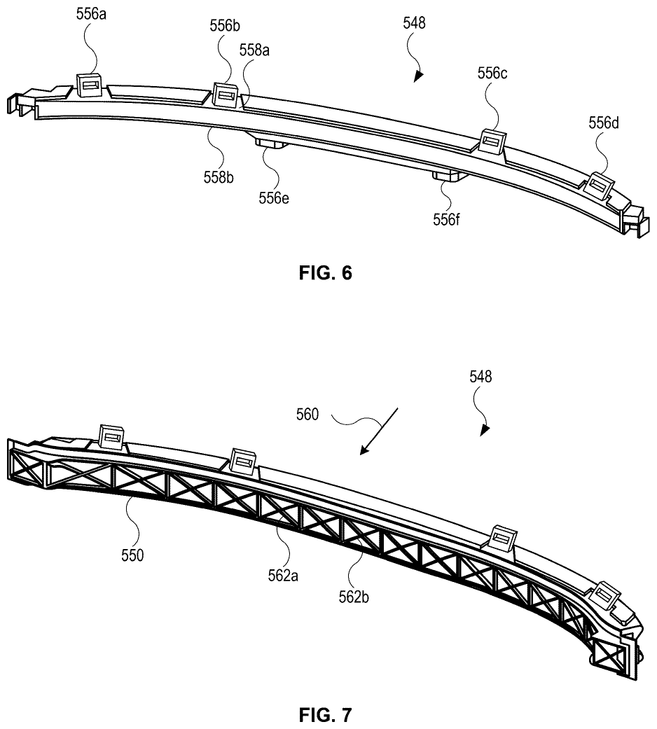

FIG. 7 illustrates a rear perspective view of the body 548, further showing the bracket 550 coupled with the body 548, in accordance with aspects of the present disclosure. The body 548 and the bracket 550 may take the form of an apparatus or a subassembly. The bracket 550 may couple or attach with a back or rear surface of the body 548. The bracket 550 may be positioned on the body 548 such when an applied force to the body 548 in the direction of the arrow 560 that causes compression of the body 548, the bracket 550 provides sufficient stiffness. Additionally, the bracket 550 may include several ribs. For example, the bracket 550 may include a rib 562a and a rib 562b (representative of one or more additional ribs). The ribs may provide the bracket 550 with additional stiffness. The bracket 550, including the ribs, may be formed through a molding operation. In this regard, the bracket 550 may include a polymer-based material such as plastic. The bracket 550 may include a stiffness that allows compression of the body 548 against the bracket 550 to trigger a sensor (e.g., sensor assembly 534 shown in FIG. 5). Moreover the bracket 550 may have a relatively lower stiffness than a metal plate on a bumper beam assembly (e.g., plate 546 of the assembly 544 shown in FIG. 5), which provides a higher likelihood of bending (e.g., in response to the applied force) than the metal plate.

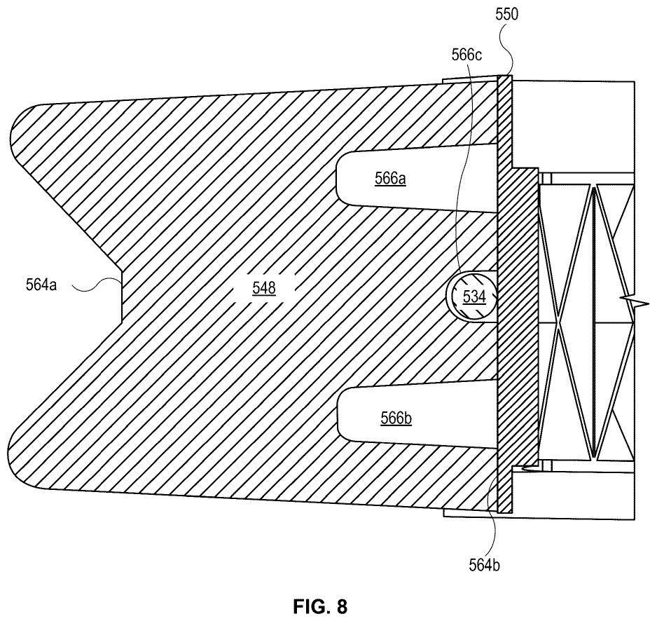

FIG. 8 illustrates a partial cross sectional view showing the body 548, in accordance with aspects of the present disclosure. As shown, the body 548 may include a surface 564a. The surface 564a may define an indentation to conform, or at least substantially conform, to a vehicle component(s) such as a front end (e.g., front end 406 of the vehicle 400 shown in FIG. 4) and/or a bumper (e.g., bumper 436 of the vehicle 400 shown in FIG. 4).

The body 548 may further include a surface 564b coupled with the bracket 550, with the surface 564b being opposite the surface 564a. As shown, the bracket 550 may cover, or at least partially cover, the surface 564b. In order to create a desired compressibility of the body 548, the body 548 may include one or more cut out portions. For example, the body 548 may include a cut out portion 566a and a cut out portion 566b. Each of the cut out portions 566a and 566b may be formed through the surface 564b of the body 548. Also, each of the cut out portions 566a and 566b represent a void in the body 548 (e.g., a removal of material of the body 548). The body 548 may further include a cut out portion 566c formed through the surface 564b and positioned between the cut out portions 566a and 566b. As shown, the sensor assembly 534 may be disposed in the cut out portion 566c, allowing the sensor assembly 534 to be positioned, or at least partially positioned, between the body 548 and the bracket 550. Further, based on the cut out portion 566c, the sensor assembly 534 may couple with the bracket 550.

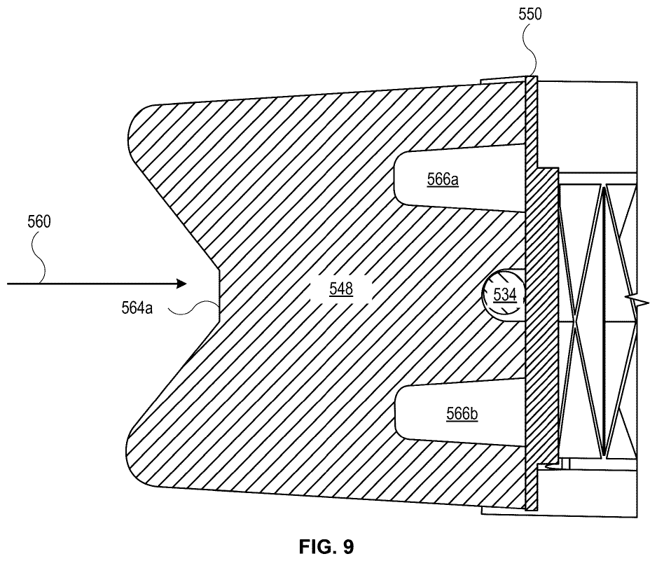

FIG. 9 illustrates a partial cross sectional view showing the body 548 in FIG. 8 under compression, in accordance with aspects of the present disclosure. As shown, an applied force in the direction of the arrow 560 is applied to the body 548, for example, at the surface 564a, with the applied force causing the body 548 to compress and reduce its overall area and volume. The compression of the body 548 may cause a portion of the body 548 to move toward the sensor assembly 534 and contact the sensor assembly 534. As a result, one or more sensing devices (e.g., sensing devices 537a and 537b shown in FIG. 5B) of the sensor assembly 534 may detect a change in pressure (e.g., increased pressures) based on contact with the body 548, and provide an output to, for example, a controller (e.g., controller 439 shown in FIG. 4), which causes the actuator to open a hood of a vehicle. Alternatively, in one or more implementations, the sensor assembly 534 takes the form of a capacitive sensor designed to detect a change in capacitance based on, for example, an increased capacitance detection due to compression of the body 548.

Further, based in part on the cut out portions 566a and 566b, the body 548 may respond by compressing from a relatively lower applied force. In this regard, the sensor assembly 534 may be triggered sooner as the body 548 compresses from a lower applied force (due to the reduced material of the body 548), causing the sensor assembly 534 to detect the body 548 sooner. Beneficially, objects of smaller size and mass (e.g., children) may be protected from an event based on the body 548 compressing from the lower size/mass object(s).

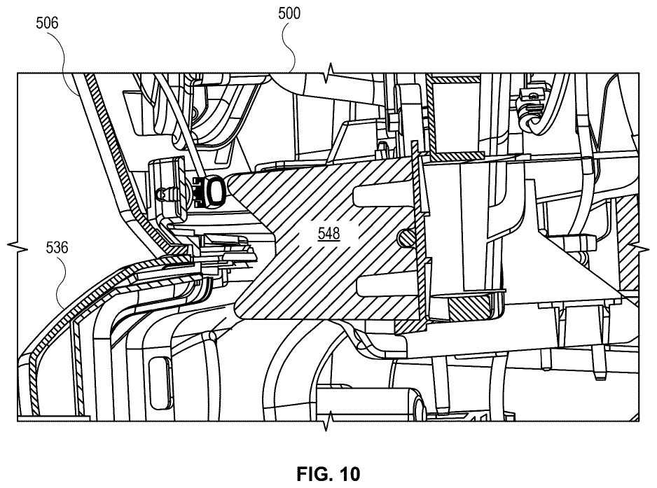

FIG. 10 illustrates a partial cross sectional view showing the body 548 integrated with a vehicle 500, in accordance with aspects of the present disclosure. As shown, the vehicle 500 may include a front end 506 and a bumper 536. The body 548, including a surface (e.g., surface 564a shown in FIG. 8) may conform, or at least partially conform, to at least one of the front end 506 or the bumper 536.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a body configured to couple with a lamp carrier of a vehicle, the body comprising:
a first surface;
a second surface opposite the first surface;
a first cut out portion formed into the second surface; and
a second cut out portion formed into the second surface, wherein in response to the body at the first surface, the body is configured to compress, based on the first cut out portion and the second cut out portion, and trigger one or more sensing devices of a sensor assembly.

2. The apparatus of claim 1, further comprising a third cut out portion formed into the second surface and positioned between the first cut out portion and the second cut out portion.

3. The apparatus of claim 2, wherein the third cut out portion is configured to receive the sensor assembly.

4. The apparatus of claim 1, further comprising a bracket configured to cover the second surface and secure with the lamp carrier.

5. The apparatus of claim 1, wherein the body comprises a foam body.

6. The apparatus of claim 5, further comprising one or more extensions that extend from the foam body, the one or more extensions configured to receive a fastener to couple the foam body with the lamp carrier.

7. The apparatus of claim 1, wherein the first surface defines an indentation configured to conform to the vehicle.

8. The apparatus of claim 1, wherein:
the body defines a first end and a second end opposite the first end, and
the first cut out portion and the second cut out portion extend from the first end to the second end.

9. A subassembly, comprising:
a lamp carrier configured to carry a plurality of lamps for a vehicle;
a bumper beam assembly comprising a bumper beam for the vehicle; and
a body configured to couple with the lamp carrier, the body comprising:
a first surface,
a second surface opposite the first surface,
a first cut out portion formed into the second surface,
a second cut out portion formed into the second surface,
a third cut out portion formed into the second surface and positioned between the first cut out portion and the second cut out portion; and
a sensor comprising one or more sensing devices positioned in the third cut out portion, wherein in response to an applied force to the body at the first surface, the body is configured to compress, based on the first cut out portion and the second cut out portion, and trigger the one or more sensing devices.

10. The subassembly of claim 9, further comprising a bracket configured to cover the second surface and secure with the lamp carrier.

11. The subassembly of claim 9, wherein the lamp carrier is carried by the bumper beam assembly.

12. The subassembly of claim 9, wherein the body comprises a foam body.

13. The subassembly of claim 12, further comprising one or more extensions that extend from the foam body, the one or more extensions configured to receive a fastener to couple the foam body with the lamp carrier.

14. The subassembly of claim 9, wherein the body is separated from the bumper beam by the bumper beam assembly.

15. The subassembly of claim 9, wherein the first surface defines an indentation configured to conform to the vehicle.

16. The subassembly of claim 9, wherein:
the body defines a first end and a second end opposite the first end, and
the first cut out portion and the second cut out portion extend from the first end to the second end.

17. A vehicle, comprising:
a bumper beam assembly comprising a bumper beam;
a bumper that convers the bumper beam;
a lamp carrier configured to carry a plurality of lamps, wherein the lamp carrier is carried by the bumper beam assembly; and
a body coupled with the lamp carrier of a vehicle, the body comprising:
a first surface,
a second surface opposite the first surface,
a first cut out portion formed into the second surface,
a second cut out portion formed into the second surface,
a third cut out portion formed into the second surface and positioned between the first cut out portion and the second cut out portion; and
a sensor comprising one or more sensing devices positioned in the third cut out portion, wherein in response to an applied force to the body at the first surface, the body is configured to compress, based on the first cut out portion and the second cut out portion, and trigger the one or more sensing devices.

18. The vehicle of claim 17, further comprising a bracket configured to cover the second surface and secure with the lamp carrier.

19. The vehicle of claim 17, wherein:
the body defines a first surface and a second end opposite the first surface, and
the first cut out portion and the second cut out portion extend from the first surface to the second surface.

20. The vehicle of claim 17, wherein the body is separated from the bumper beam by the bumper beam assembly.
